(19) United States
(12) Patent Application Publication
(10) Pub. No.: US 2026/0059615 A1
(43) Pub. Date: Feb. 26, 2026

(54) AEROSOL GENERATING APPARATUS AND HEATER FOR AEROSOL GENERATING APPARATUS

(71) Applicant: SHENZHEN FIRST UNION TECHNOLOGY CO., LTD., Shenzhen, Guangdong (CN)

(72) Inventors: Supeng KUAI, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/104,686

(22) PCT Filed: Aug. 1, 2023
(86) PCT No.: PCT/CN2023/110608

§ 371 Date: Feb. 18, 2025

(30) Foreign Application Priority Data
Aug. 18, 2022 (CN) 202210995304.0

(51) Int. Cl. H05B 3/16; A24F 40/46

(52) U.S. Cl. CPC H05B 3/16; A24F 40/46; H05B 2203/007; H05B 2203/016

(57) ABSTRACT

An aerosol generating apparatus and a heater for the aerosol generating apparatus are provided. The aerosol generating apparatus includes a heater, a heating member and a flange. The heater is inserted into an aerosol generating product for heating and includes a free front end and a tail end facing away from each other in a length direction. The heating member is at least partially extending between the free front end and the tail end and includes a first section close to the free front end and a second section close to the tail end. A color of an outer surface of the first section is different from that of an outer surface of the second section. The flange at least partially surrounds or is combined with the second section. The aerosol generating apparatus holds the heater through the flange.

### CROSS-REFERENCE TO RELATED APPLICATIONS

This application claims priority to Chinese Patent Application No. 202210995304.0, filed with the China National Intellectual Property Administration on Aug. 18, 2022 and entitled “AEROSOL GENERATING APPARATUS AND HEATER FOR AEROSOL GENERATING APPARATUS”, which is incorporated herein by reference in its entirety.

### TECHNICAL FIELDS

Embodiments of this application relate to the field of heat-not-burn aerosol generation technologies, and in particular, to an aerosol generating apparatus and a heater for the aerosol generating apparatus.

### BACKGROUND

During use of tobacco products (such as cigarettes and cigars), tobacco is burned to produce tobacco smoke. Attempts are made to replace these tobacco-burning products by making products that release compounds without burning.

An example of such products is a heating apparatus, which releases compounds by heating rather than burning materials. For example, the material may be tobacco or other non-tobacco products. These non-tobacco products may or may not include nicotine. In a known heating apparatus, a pin-shaped or needle-shaped resistance heater is inserted into tobacco or other non-tobacco products for heating.

### SUMMARY

An embodiment of this application provides an aerosol generating apparatus configured to heat an aerosol generating product to generate an aerosol, including:
a heater for being inserted into the aerosol generating product for heating, where the heater includes a free front end and a tail end facing away from each other in a length direction, and
a heating member at least partially extending between the free front end and the tail end, where the heating member includes a first section close to the free front end and a second section close to the tail end; a color of an outer surface of the first section is different from that of an outer surface of the second section; and
a flange at least partially surrounding or combined with the second section, where the aerosol generating apparatus holds the heater by means of the flange.

In some embodiments, a color difference between the color of the outer surface of the first section and the color of the outer surface of the second section are configured to be recognizable by a color sensor or human eyes.

In some embodiments, the outer surface of the first section is black; and/or the outer surface of the second section is white.

In some embodiments, the outer surface of the first section is opaque.

In some embodiments, the heater includes:
a surface coating that coats or is formed on the first section and avoids the second section, and therefore the surface coating defines different colors of the outer surface of the first section and the outer surface of the second section.

In some embodiments, the surface coating includes silicon dioxide and zirconia.

In some embodiments, a length of the first section is greater than a length of the second section.

In some embodiments, the length of the first section is 8-12 mm;
and/or the length of the second section is 4-6 mm.

In some embodiments, the outer surface of the second section is rougher than the outer surface of the first section, such that the outer surface of the second section has greater friction to prevent the flange from moving relative to the second section.

In some embodiments, the aerosol generating apparatus further includes:
a chamber having an opening and an inner bottom wall facing away from the opening, where during use, at least part of the aerosol generating product can be removably received in the chamber through the opening; and
the flange includes a first surface close to or facing the free front end; and the first surface is substantially flush with the inner bottom wall.

In some embodiments, the aerosol generating apparatus further includes:
a chamber having an opening, where during use, at least part of the aerosol generating product can be removably received in the chamber through the opening; and
the flange includes a first surface close to or facing the free front end, and the first surface is exposed to the chamber.

In some embodiments, the flange includes a first surface close to or facing the free front end; and the first surface has the same color as the outer surface of the first section.

In some embodiments, the flange includes a first surface close to or facing the free front end; and the first surface is substantially flush with a joint between the first section and the second section.

In some embodiments, the first surface has the same color as the outer surface of the first section.

In some embodiments, the first surface is black.

In some embodiments, the first surface is asymmetrical in at least one of the length direction or a width direction.

In some embodiments, the first surface has an asymmetry of rotating by 180° around a central axis of the heating member.

In some embodiments, the first surface is approximately D-shaped.

In some embodiments, the flange further includes:
a second surface facing away from the first surface; and
an outer side surface surrounding the flange in a circumferential direction of the flange, where
the second surface and/or the outer side surface has a color different from that of the first surface.

In some embodiments, the flange includes an outer side surface surrounding the flange in a circumferential direction, where
the outer side surface includes at least one flat plane and at least one curved cambered surface.

In some embodiments, the flange includes an outer side surface surrounding the flange in a circumferential direction of the flange; and
the outer side surface is asymmetrical with respect to a central axis of the heating member.

In some embodiments, the curved cambered surface is a circular arc surface; and the heating member is arranged substantially coaxially with a virtual cylinder defined by the curved cambered surface.

In some embodiments, the heater further includes:
a coating material at least partially covering a joint gap between the flange and the heating member on the first surface, to prevent residues or an aerosol condensate from the aerosol generating product from entering the joint gap along an outer surface of the heating member.

In some embodiments, the heater further includes:
a bonding material at least partially entering or penetrating into a joint gap between the flange and the heating member from the first surface, to securely bond the flange to the heating member.

In some embodiments, the bonding material includes at least one of glaze, glass or a ceramic.

In some embodiments, the flange includes a first surface close to or facing the free front end and a second surface facing away from the first surface; and
a joint gap between the flange and the heating member is invisible through the first surface; and the joint gap between the flange and the heating member is visible through the second surface.

In some embodiments, a thermal conductivity of the flange is less than 5 W/(m·K).

In some embodiments, the flange includes a ceramic.

In some embodiments, the flange includes zirconia.

In some embodiments, the flange extends in the length direction of the heater by a dimension of 1-4 mm.

In some embodiments, a distance between the flange and the tail end is 2-5 mm.

In some embodiments, a distance between the flange and the tail end is greater than the dimension by which the flange extends in the length direction of the heater.

In some embodiments, a cavity axially extending to the tail end is provided in the heating member.

In some embodiments, an inner diameter of the cavity is greater than ½ of an outer diameter of the heating member.

In some embodiments, an inner diameter of the cavity is 0.8-1.5 mm.

In some embodiments, the heating member is configured to be tubular, and the cavity is defined by a tubular hollow; and
the heating member has a tube wall thickness of 0.2-0.5 mm.

In some embodiments, the heating member is configured to be heated from room temperature to 350° C. within 10 s under supply power of 10-15 W.

In some embodiments, the heating member is formed by winding a sheet.

In some embodiments, the heating member is formed by winding the sheet clockwise.

In some embodiments, the heating member has more than one winding layer formed by winding the sheet.

In some embodiments, the sheet includes:
a windable substrate; and
a resistance heating track formed on the substrate.

In some embodiments, the substrate includes a ceramic.

In some embodiments, the substrate includes zirconia.

In some embodiments, the substrate is a thin film formed by casting a ceramic slurry including a ceramic raw material and an organic solvent.

In some embodiments, the sheet has a thickness of 0.05-0.2 mm.

In some embodiments, the heating member includes a non-integral number of winding layers.

In some embodiments, the heating member includes 3.5 winding layers.

In some embodiments, the heating member includes:
a substrate defined with an inner surface and an outer surface facing away from each other in a radial direction; and
a resistance heating track located between the inner surface and the outer surface and closer to the outer surface.

In some embodiments, the resistance heating track avoids the second section.

In some embodiments, a virtual line that connects a starting point to an ending point of winding of the sheet for the heating member is substantially in a radial direction of the heating member.

In some embodiments, the flange includes an outer side surface surrounding the flange in a circumferential direction of the flange, and the outer side surface is defined with at least one angle; and
a virtual line that connects a starting point to an ending point of winding of the sheet for the heating member substantially passes through a vertex of the angle.

In some embodiments, the flange includes:
a first side end and a second side end facing away from each other in a width direction, and a third side end and a fourth side end facing away from each other in a length direction; and
a first side surface located at the first side end and extending from the third side end to the fourth side end and a second side surface located at the second side end and extending from the third side end to the fourth side end, where the first side surface is a flat plane, and the second side surface is a curved circular arc surface.

In some embodiments, a diameter of a virtual cylinder defined by the second side surface is greater than a width dimension of the flange.

In some embodiments, a minimum distance between a central axis of the heating member and the first side surface is less than a distance between the central axis of the heating member and the second side surface;
and/or a maximum distance between the central axis of the heating member and the first side surface is greater than the distance between the central axis of the heating member and the second side surface.

In some embodiments, a radian of the second side surface is substantially equal to 71.

In some embodiments, the flange includes an outer side surface surrounding the flange in a circumferential direction of the flange, and the outer side surface has or includes only a non-closed annular circular arc surface.

In some embodiments, the heating member includes:
a substrate and a resistance heating track combined on the substrate.

In some embodiments, the resistance heating track includes:
a plurality of track segments circuitously extending in a length direction and a circumferential direction of the heating member.

In some embodiments, the resistance heating track includes only a plurality of straightly extending track segments;
and/or the resistance heating track has no arc-shaped curved track segment.

In some embodiments, the resistance heating track is defined with:
an electrical connection region close to the tail end, to conduct a current on the resistance heating track.

In some embodiments, a track width of the resistance heating track in the electrical connection region is greater than that in other parts.

In some embodiments, the resistance heating track includes at least one track segment extending in a circumferential direction of the heating member; and
a spacing region defined between the electrical connection region and a closest track segment in a longitudinal direction of the heating member, where
the flange is at least partially combined in the spacing region.

In some embodiments, the heater further includes:
a conductive pin electrically connected to the heating member, to conduct a current on the heating member.

In some embodiments, the conductive pin has a diameter of 0.2-0.5 mm.

In some embodiments, the conductive pin has a length of 20-30 mm.

In some embodiments, the conductive pin includes:
copper and a nickel layer coating the copper.

In some embodiments, a position at which the conductive pin is electrically connected to the heating member is located in the first section.

In some embodiments, the heating member is defined with an electrical connection region for electrical connection with the conductive pin; and
the electrical connection region is closer to the free front end than the flange.

In some embodiments, a distance between the electrical connection region and the flange is greater than 1 mm.

In some embodiments, the conductive pin is not exposed on an outer surface of the first section.

In some embodiments, the heater further includes:
a covering layer covering at least the conductive pin outside the heating member to fasten the conductive pin to the heating member.

In some embodiments, the covering layer is formed by cooling and solidifying a molten precursor outside the heating member.

In some embodiments, the covering layer includes glass, glaze or tin.

In some embodiments, the covering layer is partially surrounded by the flange and partially exposed outside the flange.

In some embodiments, the heating member is defined with an electrical connection region for electrical connection with the conductive pin; and
a covering layer formed by cooling and solidifying a molten precursor in the electrical connection region, and at least partially covering the electrical connection region.

In some embodiments, a wire groove is provided in an inner side wall of the flange around the heating member; and
the conductive pin is at least partially accommodated and held in the wire groove.

In some embodiments, the heating member is configured to be tubular; and
the heater further includes:
an end member close to and defining the free front end; and the end member at least partially extends into the heating member.

In some embodiments, an outer diameter of at least part of the end member is configured to gradually decrease in a direction close to the free front end.

Another embodiment of this application further provides an aerosol generating apparatus configured to heat an aerosol generating product to generate an aerosol, including:
a heater for being inserted into the aerosol generating product for heating, where the heater includes a free front end and a tail end facing away from each other in a length direction, and
a heating member at least partially extending between the free front end and the tail end, where the heating member includes a first section close to the free front end and a second section close to the tail end; and
a flange at least partially surrounding or combined with the second section, where the aerosol generating apparatus holds the heater by means of a base or the flange; and
an outer surface of the second section is rougher than an outer surface of the first section, such that the outer surface of the second section has greater friction to prevent the flange from moving relative to the second section.

Another embodiment of this application further provides an aerosol generating apparatus configured to heat an aerosol generating product to generate an aerosol, including:
a heater for being inserted into the aerosol generating product for heating, where the heater includes a free front end and a tail end facing away from each other in a length direction, and
a heating member at least partially extending between the free front end and the tail end; and
a flange at least partially surrounding or combined with the heating member, where the aerosol generating apparatus holds the heater by means of the flange;
the flange includes a first surface close to or facing the free front end, a second surface facing away from the first surface, and an outer side surface surrounding the flange in a circumferential direction of the flange; and
the first surface has a color different from those of the second surface and/or the outer side surface.

Another embodiment of this application further provides an aerosol generating apparatus configured to heat an aerosol generating product to generate an aerosol, including:
a chamber having an opening and an inner bottom wall facing away from the opening, where during use, at least part of the aerosol generating product can be removably received in the chamber through the opening;
a heating member at least partially extending in the chamber, to be inserted into the aerosol generating product for heating; and
a flange at least partially surrounding or combined with the heating member, where the aerosol generating apparatus holds the heater by means of the flange; and the flange includes a first surface close to or facing the free front end, and the first surface is substantially flush with the inner bottom wall.

Another embodiment of this application further provides an aerosol generating apparatus configured to heat an aerosol generating product to generate an aerosol, including:
a heating member for being inserted into the aerosol generating product for heating; and
a flange at least partially surrounding or combined with the heating member, where the aerosol generating apparatus holds the heater by means of the flange;
the flange includes an outer side surface surrounding the flange in a circumferential direction; the outer side surface includes at least one flat plane and at least one curved circular arc surface; and
the heating member is arranged substantially coaxially with a virtual cylinder defined by the curved circular arc surface.

Another embodiment of this application further provides an aerosol generating apparatus configured to heat an aerosol generating product to generate an aerosol, including:
a heating member for being inserted into the aerosol generating product for heating, where
the heating member includes a non-integral number of winding layers formed by winding a sheet.

In some embodiments, the heating member includes 3.5 winding layers.

Another embodiment of this application further provides an aerosol generating apparatus configured to heat an aerosol generating product to generate an aerosol, including:
a heating member for being inserted into the aerosol generating product for heating, where the heating member is formed by winding a sheet; and
a flange at least partially surrounding or combined with the heating member, where the aerosol generating apparatus holds the heater by means of the flange; the flange includes an outer side surface surrounding the flange in a circumferential direction of the flange, and the outer side surface is defined with at least one angle; and
a virtual line that connects a starting point to an ending point of winding of the sheet for the heating member substantially passes through a vertex of the angle.

Another embodiment of this application further provides an aerosol generating apparatus configured to heat an aerosol generating product to generate an aerosol, including:
a heating member for being inserted into the aerosol generating product for heating, where
a flange at least partially surrounding or combined with the heating member, where the aerosol generating apparatus holds the heater by means of the flange; and the flange includes:
a first side end and a second side end facing away from each other in a width direction, and a third side end and a fourth side end facing away from each other in a length direction; and a first side surface located at the first side end and extending from the third side end to the fourth side end and a second side surface located at the second side end and extending from the third side end to the fourth side end, where the first side surface is a flat plane, and the second side surface is a curved circular arc surface; and
a minimum distance between a central axis of the heating member and the first side surface is less than a distance between the central axis of the heating member and the second side surface; and/or a maximum distance between the central axis of the heating member and the first side surface is greater than the distance between the central axis of the heating member and the second side surface.

Another embodiment of this application further provides an aerosol generating apparatus configured to heat an aerosol generating product to generate an aerosol, including:
a heating member for being inserted into the aerosol generating product for heating, where the heating member includes:
a substrate defined with an inner surface and an outer surface facing away from each other in a radial direction of the heating member; and
a resistance heating track located between the inner surface and the outer surface and closer to the outer surface.

Another embodiment of this application further provides an aerosol generating apparatus configured to heat an aerosol generating product to generate an aerosol, including:
a heater for being inserted into the aerosol generating product for heating, where the heater includes a free front end and a tail end facing away from each other in a length direction, and
a heating member at least partially extending between the free front end and the tail end;
a flange at least partially surrounding or combined with the heating member, where the aerosol generating apparatus holds the heater by means of the flange; the flange includes a first surface close to or facing the free front end; and
a coating material at least partially covering a joint gap between the flange and the heating member on the first surface, to prevent residues or an aerosol condensate from the aerosol generating product from entering the joint gap along an outer surface of the heating member.

Another embodiment of this application further provides an aerosol generating apparatus configured to heat an aerosol generating product to generate an aerosol, including:
a heating member for being inserted into the aerosol generating product for heating, where the heating member has a cavity extending in a length direction; and an inner diameter of the cavity is greater than ½ of an outer diameter of the heating member, such that the heating member can be heated from room temperature to 350° C. within 10 s under supply power of 10-15 W.

Another embodiment of this application further provides an aerosol generating apparatus configured to heat an aerosol generating product to generate an aerosol, including:
a heater for being inserted into the aerosol generating product for heating, where the heater includes a free front end and a tail end facing away from each other in a length direction, and
a heating member at least partially extending between the free front end and the tail end, where the heating member is defined with an electrical connection region;
a conductive pin connected to the electrical connection region, to conduct a current on the heating member; and
a flange at least partially surrounding or combined with the heating member, where the aerosol generating apparatus holds the heater by means of the flange; and
the electrical connection region is closer to the free front end than the flange.

Another embodiment of this application further provides an aerosol generating apparatus configured to heat an aerosol generating product to generate an aerosol, including:
a heater for being inserted into the aerosol generating product for heating, where the heater includes a free front end and a tail end facing away from each other in a length direction, and
a heating member at least partially extending between the free front end and the tail end, where the heating member is defined with an electrical connection region;
a conductive pin connected to the electrical connection region, to conduct a current on the heating member; and
a covering layer that is formed by cooling and solidifying a molten precursor in the electrical connection region, and covers at least the conductive pin to fasten the conductive pin to the heating member.

Another embodiment of this application further provides an aerosol generating apparatus configured to heat an aerosol generating product to generate an aerosol, including:
a heating member at least partially extending in front of a free front end and a tail end, to be inserted into the aerosol generating product for heating; and
a flange at least partially surrounding or combined with the heating member, where the aerosol generating apparatus holds the heater by means of the flange;
the heating member includes:
a substrate and a resistance heating track combined on the substrate; and
the resistance heating track includes:
an electrical connection region close to the tail end, to conduct a current on the resistance heating track;
at least one track segment extending in a circumferential direction of the heating member; and
a spacing region defined between the electrical connection region and a closest track segment in a longitudinal direction of the heating member, where the flange is at least partially combined in the spacing region.

Another embodiment of this application further provides an aerosol generating apparatus configured to heat an aerosol generating product to generate an aerosol, including:
a heating member for being inserted into the aerosol generating product for heating, where the heating member is formed by winding a sheet; the sheet includes a thin film formed by casting a ceramic slurry of a ceramic raw material and an organic solvent, and a resistance heating track formed on the thin film; and
a flange at least partially surrounding or combined with the heating member, where the aerosol generating apparatus holds the heater by means of the flange; and the flange has an asymmetry of rotating by 180° around a central axis of the heating member.

Another embodiment of this application further provides an aerosol generating apparatus configured to heat an aerosol generating product to generate an aerosol, including:
a heater for being inserted into the aerosol generating product for heating, where the heater includes a free front end and a tail end facing away from each other in a length direction, and
a heating member at least partially extending between the free front end and the tail end;
a flange at least partially surrounding or combined with the heating member, where the aerosol generating apparatus holds the heater by means of the flange; the flange includes a first surface close to or facing the free front end; and
a bonding material at least partially entering or penetrating into a joint gap between the flange and the heating member from the first surface, to securely bond the flange to the heating member.

Another embodiment of this application further provides a heater for an aerosol generating apparatus, including a free front end and a tail end facing away from each other in a length direction, and
a heating member at least partially extending between the free front end and the tail end, to be inserted into an aerosol generating product for heating, where the heating member includes a first section close to the free front end and a second section close to the tail end; a color of an outer surface of the first section is different from that of an outer surface of the second section; and
a flange at least partially surrounding or combined with the second section.

Another embodiment of this application further provides a heater for an aerosol generating apparatus, including a free front end and a tail end facing away from each other in a length direction, and
a heating member at least partially extending between the free front end and the tail end, to be inserted into an aerosol generating product for heating, where the heating member includes a first section close to the free front end and a second section close to the tail end; and
a flange at least partially surrounding or combined with the second section, where
an outer surface of the second section is rougher than an outer surface of the first section, such that the outer surface of the second section has greater friction to prevent the flange from moving relative to the second section.

Another embodiment of this application further provides a heater for an aerosol generating apparatus, including a free front end and a tail end facing away from each other in a length direction, and
a heating member at least partially extending between the free front end and the tail end, to be inserted into an aerosol generating product for heating; and
a flange at least partially surrounding or combined with the heating member, where the flange includes an outer side surface surrounding the flange in a circumferential direction; the outer side surface includes at least one flat plane and at least one curved circular arc surface; and
the heating member is arranged substantially coaxially with a virtual cylinder defined by the curved circular arc surface.

Another embodiment of this application further provides a heater for an aerosol generating apparatus, including a free front end and a tail end facing away from each other in a length direction, and
a heating member at least partially extending in front of a free front end and a tail end, to be inserted into the aerosol generating product for heating; and
a flange at least partially surrounding or combined with the heating member, where
the heating member includes:
a substrate and a resistance heating track combined on the substrate; and
the resistance heating track includes:
an electrical connection region close to the tail end, to conduct a current on the resistance heating track;
at least one track segment extending in a circumferential direction of the heating member; and
a spacing region defined between the electrical connection region and a closest track segment in a longitudinal direction of the heating member, where the flange is at least partially combined in the spacing region.

Another embodiment of this application further provides a heater for an aerosol generating apparatus, including a free front end and a tail end facing away from each other in a length direction, and
a heating member at least partially extending in front of a free front end and a tail end, to be inserted into the aerosol generating product for heating, where the heating member is formed by winding a sheet; the sheet includes a thin film formed by casting a ceramic slurry of a ceramic raw material and an organic solvent, and a resistance heating track formed on the thin film; and
a flange at least partially surrounding or combined with the heating member, where the flange has an asymmetry of rotating by 180° around a central axis of the heating member.

Another embodiment of this application further provides a heater for an aerosol generating apparatus, including a free front end and a tail end facing away from each other in a length direction, and
a heating member at least partially extending in front of a free front end and a tail end, to be inserted into the aerosol generating product for heating, where the heating member includes:
a substrate defined with an inner surface and an outer surface facing away from each other in a radial direction of the heating member; and
a resistance heating track located between the inner surface and the outer surface and closer to the outer surface.

Another embodiment of this application further provides a heater for an aerosol generating apparatus, including a free front end and a tail end facing away from each other in a length direction, and
a heating member at least partially extending in front of a free front end and a tail end, to be inserted into the aerosol generating product for heating, where the heating member is defined with an electrical connection region;
a conductive pin connected to the electrical connection region, to conduct a current on the heating member; and
a covering layer that is formed by cooling and solidifying a molten precursor in the electrical connection region, and covers at least the conductive pin to fasten the conductive pin to the heating member.

Different color sections are formed on the heating member of the aerosol generating apparatus, such that identification and positioning by a color sensor or device in automatic assembly or preparation are facilitated.

### BRIEF DESCRIPTION OF THE DRAWINGS

One or more embodiments are exemplarily described by corresponding accompanying drawings. These exemplary descriptions do not constitute a limitation on the embodiments, and elements with the same reference numerical signs in the accompanying drawings represent similar elements. Unless otherwise specified, the accompanying drawings do not constitute a limitation on scale.

FIG. 1 is a schematic diagram of an aerosol generating apparatus according to an embodiment;

FIG. 2 is a schematic diagram of a structure of a heater in FIG. 1 from a perspective;

FIG. 3 is a schematic sectional view of the heater in FIG. 2 from a perspective;

FIG. 4 is a schematic diagram of unfolding of a sheet in FIG. 3 before winding;

FIG. 5 is a schematic diagram of unfolding of a sheet according to another embodiment before winding;

FIG. 6 is a schematic cross-sectional view of a heater from a perspective;

FIG. 7 is a schematic diagram of a conductive track in another varied embodiment; and

FIG. 8 is a schematic diagram of unfolding of a sheet according to another varied embodiment before winding.

### DETAILED DESCRIPTION

To facilitate the understanding of this application, this application is described in more detail below with reference to accompanying drawings and specific implementations.

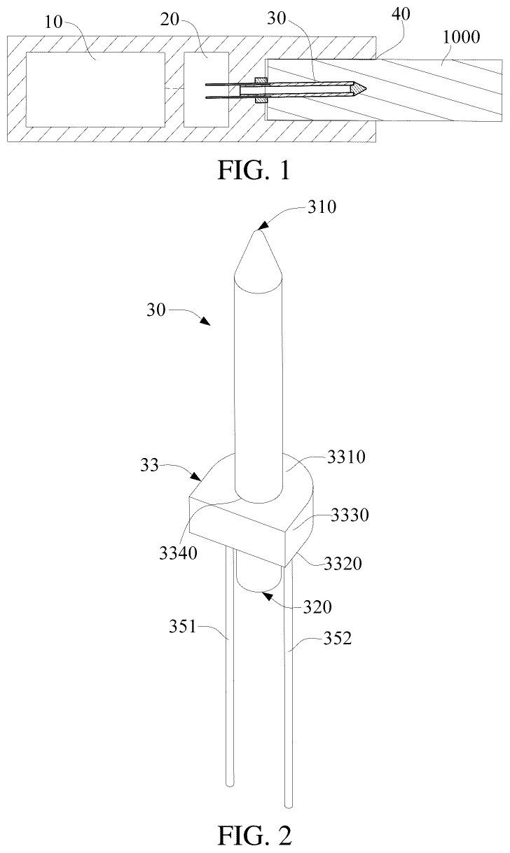

An embodiment of this application provides an aerosol generating apparatus, with a structure shown in FIG. 1, including:
a chamber having an opening 40, where during use, an aerosol generating product 1000 can be removably received in the chamber through the opening 40 of the chamber;
a heater 30, which at least partially extends in the chamber, and is inserted into the aerosol generating product 1000 for heating when the aerosol generating product 1000 is received in the chamber, so that the aerosol generating product 1000 releases various volatile compounds, where these volatile compounds are formed only by heating treatment;
a battery cell 10 for supplying power; and
a circuit 20 for conducting a current between the battery cell 10 and the heater 30.

In a preferred embodiment, a direct current supply voltage provided by the battery cell 10 ranges from about 2.5 V to about 9.0 V, and an amperage of a direct current that can be provided by the battery cell 10 ranges from about 2.5 A to about 20 A.

In a preferred embodiment, the heater 30 is generally in the shape of a pin, a needle, a rod, a bar, a column, a sheet or a plate, which is advantageous for insertion into the aerosol generating product 1000; and in addition, the heater 30 may have a length of approximately 12-25 millimeters and an outer diameter of approximately 2-4 millimeters.

Further, in an optional implementation, the aerosol generating product 1000 is preferably made of a tobacco containing material that releases volatile compounds from a matrix when heated, or may be made of a non-tobacco material that can be suitable for electric heating smoke formation after being heated. The aerosol generating product 1000 is preferably made of a solid matrix, which may include one or more of a powder, particles, fragments, strips, or sheets of one or more of vanilla leaves, tobacco leaves, homogeneous tobacco, and expanded tobacco; or the solid matrix may contain additional tobacco or non-tobacco volatile aroma compounds to be released when the matrix is heated.

During the implementation, the heater 30 may generally include a resistance heating element, and an auxiliary base material for assisting the resistance heating element in fixation, preparation, and the like. For example, in some implementations, the resistance heating element is in the shape or form of a spiral coil. Alternatively, in some other implementations, the resistance heating element is in the form of a conductive track combined on the substrate. Alternatively, in some other implementations, the resistance heating element is in the shape of a sheet.

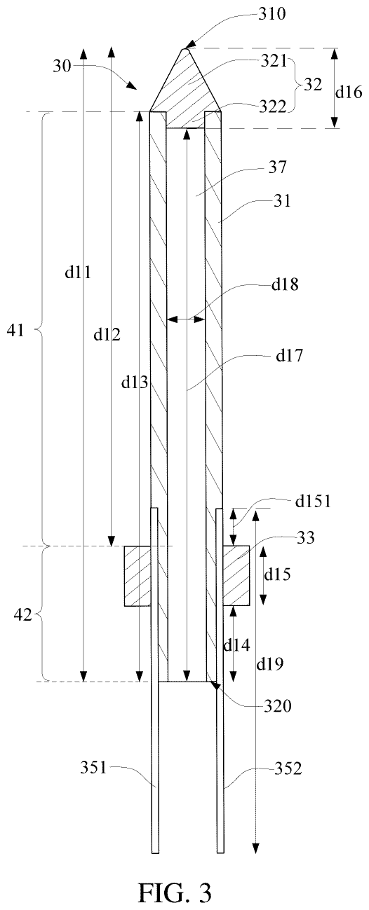

Further, FIG. 2 and FIG. 3 each are a schematic diagram of a heater 30 according to an embodiment. The heater 30 according to this embodiment includes a free front end 310 and a tail end 320 facing away from each other in a length direction, where the free front end 310 has a tapered tip for insertion into the aerosol generating product 1000. Specifically, the heater 30 includes:
a heating member 31 configured in a tubular shape extending between the free front end 310 and the tail end 320, where the heating member 31 is close to and defines the tail end 320; and the tubular heating member 31 has a cavity 37 that runs through the heating member 31 in an axial direction;
and an end member 32 close to and defining the free front end 310, where the end member 32 at least partially extends into the cavity 37 of the heating member 31 from an end of the heating member 31 close to the free front end 310.

Specifically, the end member 32 includes: a portion 321 and a portion 322 that are sequentially arranged in a length direction, where an outer diameter or a cross-sectional area of the portion 321 is configured in a tapered shape gradually decreasing in a direction close to the free front end 310, and the portion 322 is in a columnar shape; and
during assembly, the portion 322 extends into the cavity 37 of the heating member 31 from the end of the heating member 31 close to the free front end 310; and the portion 321 abuts against the end of the heating member 31 close to the free front end 310.

After assembly, the cavity 37 is closed or blocked by the end member 32 at a position close to the free front end 310. The cavity 37 is open at the tail end 320 and is defined with an opening.

The portion 321 has a maximum outer diameter at a position facing away from the free front end 310 or adjacent to portion 322; the maximum outer diameter of the portion 321 is basically the same as an outer diameter of heating member 31; an outer diameter of the portion 322 is the same as an inner diameter of the cavity 37; and then a step is defined between the portion 321 and the portion 322 to abut against the end of the heating member 31 close to the free front end 310.

After assembly, the portion 321 of the end member 32 is exposed outside the heating member 31, while the portion 322 extends into the heating member 31.

The heater 30 further includes:
a flange 33 at least partially surrounding or combined with the heating member 31; and moreover, the flange 33 is closer to the tail end 320 than to the free front end 310. During mounting, the aerosol generating apparatus 100 enables the heater 30 to be stably assembled in the aerosol generating apparatus 100 by clamping or holding the flange 33. In the embodiment, the heating member 31 penetrates or passes through the flange 33.

Further referring to FIG. 3, a length d11 by which the heater 30 extends is approximately 12-25 mm; and in a specific embodiment, the length d11 by which the heater 30 extends is 19 mm.

A distance d12 between the flange 33 and the free front end 310 is approximately 10-16 mm; and in a specific embodiment, the distance d12 between the flange 33 and the free front end 310 is 14 mm.

A length d13 by which the heating member 31 extends is approximately 14-18 mm; and in a specific embodiment, the length d13 by which the heating member 31 extends is approximately 16 mm. The length d13 by which the heating member 31 is greater than 80% of the length d11 by which the heater 30 extends. A wall thickness of the tubular heating member 31 is approximately 0.2-0.5 mm. In a specific embodiment, the wall thickness of the tubular heating member 31 is 0.4 mm.

A distance d14 between the flange 33 and the tail end 320 is approximately 2-5 mm; and in a specific embodiment, the distance d14 between the flange 33 and the tail end 320 is 3 mm.

A dimension d15 by which the flange 33 extends in a length direction of the heater 30 is approximately 1-4 mm; and in a specific embodiment, the dimension d15 by which the flange 33 extends is 1.95 mm. The dimension d15 by which the flange 33 extends is less than the distance d14.

A dimension d16 by which the end member 32 extends in the length direction of the heater 30 is approximately 3-6 mm; and in a specific embodiment, the dimension d16 by which the end member 32 extends is 4 mm. A length of the portion 321 of the end member 32 is greater than a length of the portion 322. The length of the portion 321 is approximately 2-4 mm, and the length of the portion 322 is approximately 1-2 mm.

After assembly, the portion 322 extends into the heating member 31. A length d17 by which the cavity 37 extends is approximately 12-16 mm; and in a specific embodiment, the length d17 by which the cavity 37 extends is 15 mm.

An inner diameter d18 of the cavity 37 is approximately 0.8-1.5 mm; and in a specific embodiment, the inner diameter d18 of the cavity 37 is 1.3 mm. In some embodiments, the inner diameter d18 of the cavity 37 is greater than ½ of the outer diameter of heating member 31. This is beneficial to limiting the volume and heat capacity of the heating member 31 and improving heating efficiency during use.

By limiting the volume and heat capacity of the heating member 31, the heating member 31 can be heated from room temperature to 350° C. within 10 s under supply power of 10-15 W.

In some embodiments, the flange 33 is made of an organic polymer such as PEEK, or a ceramic such as an alumina ceramic and a zirconia ceramic, or the like.

In some embodiments, the flange 33 includes zirconia.

In some embodiments, the flange 33 is molded from the above moldable material, such as the PEEK or the ceramic, around the heating member 31.

A thermal conductivity of the flange 33 is less than 5 W/(m·K), which is beneficial to reducing more heat transfer from the heating member 31 to the flange 33. In some other embodiments, the thermal conductivity of the flange 33 is less than 3 W/(m·K); and in some other embodiments, the thermal conductivity of the flange 33 is approximately 2 W/(m·K).

In some embodiments, the end member 32 is made of a metal, or an alloy, or a ceramic, or the like. In some embodiments, the end member 32 includes a ceramic, such as a zirconia ceramic.

Further referring to FIG. 2, the flange 33 has a surface 3310 and a surface 3320 that face away from each other in a circumferential direction, and an outer side surface 3330 extending between the surface 3310 and the surface 3320. In the embodiment, the outer side surface 3330 surrounds the flange 33 in the circumferential direction. It can be understood that the surface 3310 and the surface 3320 are a first surface and a second surface.

In the embodiment, the surface 3310 and the surface 3320 have different colors, which is beneficial to identifying an orientation in preparation and assembly. Alternatively, in some embodiments, the surface 3310 has a color different from that of the surface 3320 and/or that of the outer side surface 3330. For example, in some embodiments, a color difference of the surface 3310 is sufficient to be recognized by a color sensor or by human eyes.

In some embodiments, the surface 3310 is black. The surface 3320 and/or the outer side surface 3330 is white.

After assembly, the surface 3310 is exposed to the chamber. After assembly, the surface 3310 is flush with an inner bottom wall of the chamber facing away from the opening 40.

Further referring to FIG. 3, the heating member 31 includes a section 41 and a section 42 sequentially arranged in the length direction. The section 41 is mainly a portion for insertion into the aerosol generating product 1000 for heating, and the section 42 is mainly a portion used for mounting and fixing. In some embodiments, the section 41 is close to the free front end 310 and the section 42 is close to the tail end 320. A length of the first section 41 is greater than a length of the second section 42. For example, the section 41 may have a length of approximately 8-12 mm, and the section 42 may have a length of 4-6 mm. It can be understood that the section 41 and the section 42 are a first section and a second section.

Further, in some embodiments, an outer surface of the section 41 of the heating member 31 has a color different from that of the section 42, to provide a positioning indication for combining the flange 33 with the heating member 31. Specifically, for example, in some embodiments, a surface of the section 41 is black; and a surface of the section 42 is white. The flange 33 surrounds and is combined on the section 42. After assembly, the surface 3310 of the flange 33 is flush with a joint between the section 41 and the section 42 and the like. After assembly, the section 42 extends at least partially out of the flange 33.

In some other embodiments, the outer surface of the section 42 is rougher than the outer surface of the section 41, so that when the flange 33 surrounds and is combined on the section 42, the section 42 has relatively larger surface friction than the section 41, which is beneficial to preventing the flange 33 from moving relative to the section 42 and/or the heating member 31 in an axial direction.

Further referring to FIG. 2, in some other implementations, there is a gap 3340 between the surface 3310 of the flange 33 and the heating member 31; and the heater 30 further includes:
a bonding material or a coating material covering or closing the gap 3340 at the surface 3310, or the bonding material further at least partially penetrates into the gap 3340, to tightly bond the flange 33 to the heating member 31. The gap 3340 is covered or closed by the bonding material or the coating material, to prevent residues or an aerosol condensate from the aerosol generating product 1000 from flowing or penetrating along the surface of the section 41 into the gap 3340 and/or between the flange 33 and the section 42. The bonding material or the coating material includes, for example, glaze, glass, a ceramic, and the like.

Alternatively, in some embodiments, the outer surface of the section 41 of the heating member 31, the surface 3310 of the flange 33, and an outer surface of the end member 32 form colors different from those of other parts, to facilitate identification and positioning by a color sensor or device in automatic assembly or preparation. For example, in some embodiments, the outer surface of the section 41 of the heating member 31, the surface 3310 of the flange 33, and the outer surface of the end member 32 are configured in black. The color of the outer surface of the section 41 is opaque. For example, black surface coatings are formed by spraying or surface treatment, and the like to make their outer surfaces black.

In some embodiments, the surface coating includes silicon dioxide and zirconia.

Further referring to FIG. 2 and FIG. 3, the heater 30 further includes: a conductive pin 351 and a conductive pin 352 for supplying power to the heating member 31 or for conducting a current on the heating member 31.

During the implementation, the conductive pin 351 and/or the conductive pin 352 has the same length. For example, a length d19 by which the conductive pin 351 and/or the conductive pin 352 extends is approximately 20-30 mm. In some embodiments, the conductive pin 351 and/or the conductive pin 352 has a diameter of 0.2-0.5 mm. For example, the conductive pin 351 and/or the conductive pin 352 has a diameter of 0.35 mm.

The conductive pin 351 and/or the conductive pin 352 is made of a metal or an alloy with low resistivity. For example, the conductive pin 351 and/or the conductive pin 352 includes gold, silver, copper or an alloy thereof. Alternatively, in some other implementations, the conductive pin 351 and/or the conductive pin 352 is a copper wire with a surface electroplated or sprayed or coated with a nickel layer.

During assembly, the conductive pin 351 and/or the conductive pin 352 passes through the flange 33. The conductive pin 351 and/or the conductive pin 352 is connected to the section 41 of the heating member 31.

In some embodiments, a position at which the conductive pin 351 and/or the conductive pin 352 is connected to the heating member 31 is closer to the free front end 310 than the flange 33. For example, as shown in FIG. 3, a distance d151 between the flange 33 and the position at which the conductive pin 351 and/or the conductive pin 352 is connected to the heating member 31 is greater than 1 mm. For example, in some embodiments, the distance d151 is between 1 mm and 3 mm.

In some embodiments, the conductive pin 351 and/or the conductive pin 352 is not exposed or is exposed outside the heating member 31 and/or the section 41; and the conductive pin 351 and/or the conductive pin 352 extends to the outside of the tail end 320 from the position at which the conductive pin and/or the conductive pin is connected to the heating member 31, and then is connected to the circuit 20.

In some embodiments, the heating member 31 is formed by winding a sheet 31a. The heating member 31 includes at least two winding layers.

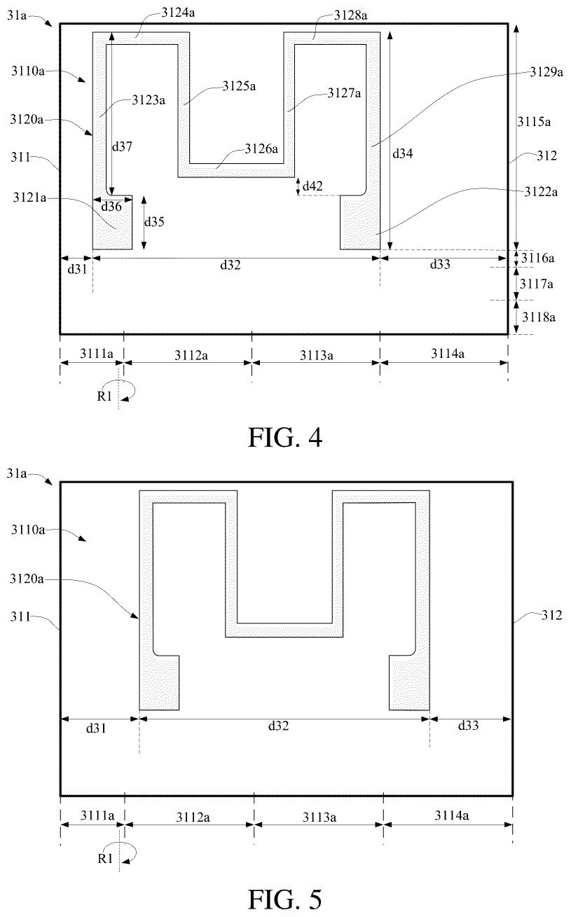

Further, for example, FIG. 4 is a schematic diagram of a sheet 31a after a heating member 31 is unfolded in a circumferential direction in an embodiment. The sheet 31a wound to form the heating member 31 includes:
a windable sheet-like substrate 3110a, which is roughly configured in a square or rectangular shape; and
a resistance heating track 3120a formed on a surface of the windable substrate 3110a by printing, spraying, or other means.

In some embodiments, the windable substrate 3110a is a thin film formed, by a casting process in a casting device, from a ceramic slurry formed by mixing a ceramic powder with an organic solvent. The windable substrate 3110a has a thickness of approximately 0.05-0.2 mm. In some examples, the substrate 3110a formed by casting the ceramic slurry includes zirconia. The organic solvent is usually an organic solvent in the field of ceramic preparation, and usually includes one or more of anhydrous alcohol, toluene, xylene, tetrahydrofuran, tripropylene glycol monomethyl ether, and trichloroethane.

For example, the unfolded sheet 31a has a first side 311 and a second side 312 facing away from each other; and the windable substrate 3110a has a region 3111a, a region 3112a, a region 3113a and a region 3114a that are sequentially provided between the first side 311 and the second side 312. A distance between the first side 311 and the second side 312 can be correspondingly increased or decreased by a quantity of winding layers required in preparation.

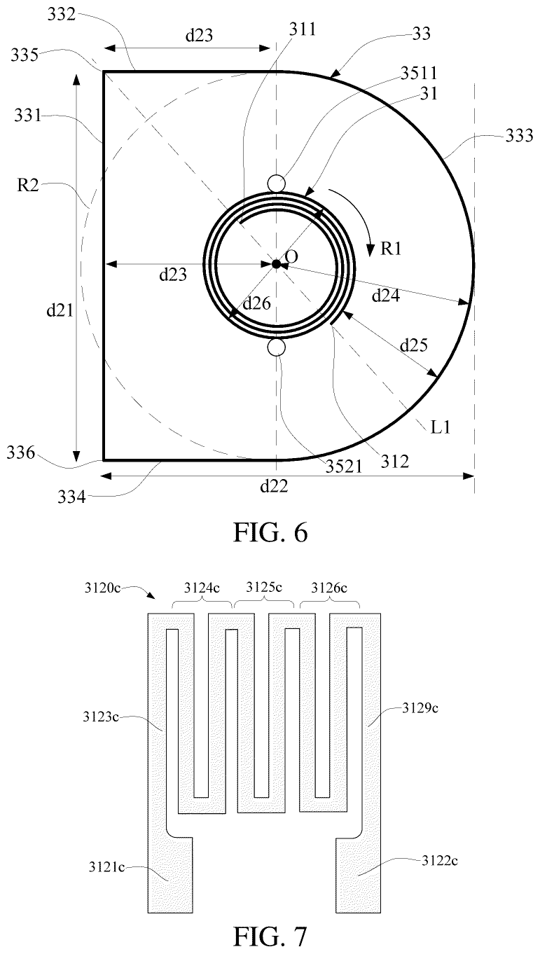

In some embodiments, the heating member 31 includes 2-5 winding layers. For example, in the embodiments shown in FIG. 4 and FIG. 6, the heating member 31 has 3.5 winding layers. During the implementation, starting from the first side 311 of the sheet 31, circumferential winding is performed, and one winding layer is formed each time winding is performed by 360°.

The width of the region 3111a is basically equal to a dimension required for 0.5 winding, and each of widths of the region 3112a and/or the region 3113a and/or the region 3114a is basically equal to a dimension required for one winding. As shown by an arrow R1 in FIG. 4, the heating member 31 with 3.5 winding layers can be obtained after the first side 311 is attached to the outside of a rod-shaped jig clockwise for winding.

In some embodiments, the sheet 31a is wound and then sintered, so that winding layers formed by winding the sheet 31a formed by casting the ceramic slurry are bonded and solidified, and the tubular heating member 31 can be obtained.

In some examples, during winding of the sheet 31a, the resistance heating track 3120a is outward. Alternatively, when the sheet 31a is wound around the rod-shaped jig, the resistance heating track 3120a is arranged away from the rod-shaped jig. During the implementation, a surface of the sheet 31a without the resistance heating track 3120a is attached to the rod-shaped jig for winding.

In some embodiments, the resistance heating track 3120a is made of a metal material, a metal alloy, graphite, carbon, a conductive ceramic or another composite material of a ceramic material and a metal material, with appropriate impedance. An appropriate metal or alloy material includes at least one of nickel, cobalt, zirconium, titanium, a nickel alloy, a cobalt alloy, a zirconium alloy, a titanium alloy, a nickel chromium alloy, a nickel iron alloy, an iron chromium alloy, an iron chromium aluminum alloy, an iron manganese aluminum-based alloy, or stainless steel, and the like.

In some embodiments, the resistance heating track 3120a is not located at a center of the sheet 31a, or the resistance heating track 3120a is deviated from the center or a geometric center of the sheet 31a.

For example, in the embodiment shown in FIG. 4, the resistance heating track 3120a has an extension length d32 between the first side 311 and the second side 312; and the resistance heating track 3120a has a distance d31 from the first side 311 and a distance d33 from the second side 312.

In the embodiment of FIG. 4, the distance d33 is greater than the distance d31, so that the resistance heating track 3120a is closer to the first side 311 and relatively farther away from the second side 312. In some embodiments shown in FIG. 4, the distance d33 between the resistance heating track 3120a and the second side 312 is greater than a dimension required for one winding of the sheet. A region defined by the distance d33 is blank, and then at least one complete winding layer can be formed at a wound outermost layer in the region defined by the distance d33 after winding, to coat or cover the resistance heating track 3120a at a surface layer, so as to prevent the wound resistance heating track 3120a from being exposed on the outermost surface.

Alternatively, in some other varied embodiment, for example, as shown in FIG. 5, the resistance heating track 3120a is arranged in a central region between the first side 311 and the second side 312. That is, the distance d31 between the resistance heating track 3120a and the first side 311 and the distance d33 between the resistance heating track and the second side 312 are the same or close. In the embodiment, the distance d33 is less than the dimension required for one winding, so that part of the resistance heating track 3120a may be exposed after winding, and the resistance heating track 3120a exposed on the outer surface may be coated or covered by a coating material.

Further referring to FIG. 4, the sheet 31a has an upper end and a lower end facing away from each other in a longitudinal direction; and after preparation, the tail end 320 of the heater 30 is defined and formed by the lower end. The dimension of the sheet 31a in the longitudinal direction is the length d13 by which the heating member 31 extends, which is approximately 14-18 mm, such as 16 mm.

Further referring to FIG. 4, the sheet 31a has a region 3115a, a region 3116a, a region 3117a, and a region 3118a that are sequentially provided in the longitudinal direction. During the implementation, the region 3115a is mainly a heating region in which the resistance heating track 3120a is formed; the region 3117a is a flange 33 mounting region surrounded and combined by the flange 33 after winding; the region 3116a is a spacing region that isolates the flange 33 from the resistance heating track 3120a; and the region 3118a is an exposed region in which the section 42 defining the heating member 31 is exposed outside the flange 33.

In the embodiment, a length by which the region 3117a extends is the length d15 by which the flange 33 extends; a length by which the region 3116a extends is the distance d151 between the flange and the position at which the conductive pin 351 and/or the conductive pin 352 is connected to the heating member 31; and a length by which the region 3118a extends is the distance d14 between the flange 33 and the tail end 320.

As shown in FIG. 4, a dimension d34 by which the resistance heating track 3120a extends in a longitudinal direction of the sheet 31a is approximately 8-14 mm; and in a specific embodiment, the dimension d34 by which the resistance heating track 3120a extends in the longitudinal direction of the sheet 31a is 12 mm. A length by which the region 3115a extends is slightly greater than the length by which the resistance heating track 3120a extends, for example, greater than 1-2 mm. During preparation, a distance between the resistance heating track 3120a and the upper end of the sheet 31a is 1-2 mm.

Further referring to FIG. 4, the resistance heating track 3120a meanders or circuitously extends in the region 3115a; and a track width of the resistance heating track 3120a is approximately 0.5-5 mm, such as 2 mm.

Further referring to FIG. 4, the resistance heating track 3120a includes:
a track segment 3123a and a track segment 3129a that extend in the longitudinal direction of the sheet 31a, where the track segment 3123a is close to the first side 311, and the track segment 3129a is close to the second side 312.

The track segment 3123a has a portion 3121a with an increased width at an end close to the lower end/tail end 320, and the track segment 3129a has a portion 3122a with an increased width at an end close to the lower end/tail end 320. During the implementation, the portion 3121a with an increased width and/or the portion 3122a with an increased width each define an electrical connection position or region for supplying power to the resistance heating track 3120a. During the implementation, one of the conductive pin 351 and the conductive pin 352 is connected to the portion 3121a with an increased width to form electric conduction, and the other is connected to the portion 3122a with an increased width to form electric conduction, so as to supply power to the resistance heating track 3120a in use.

During the implementation, a length d35 by which the portion 3121a with an increased width and/or the portion 3122a with an increased width extends is approximately 3-6 mm; and each width dimension d36 of the portion 3121a with an increased width and/or the portion 3122a with an increased width is approximately 2-5 mm.

Further referring to FIG. 4, the resistance heating track 3120a further includes:
a plurality of track segments circuitously or crookedly extending between the track segment 3123a and the track segment 3129a, such as a track segment 3124a, a track segment 3125a, a track segment 3126a, a track segment 3127a, and a track segment 3128a.

Further, the track segment 3126a is closest to the portion 3121a with an increased width and/or the portion 3122a with an increased width in a longitudinal direction; and there is a distance d42 between the track segment 3126a and the portion 3121a with an increased width and/or the portion 3122a with an increased width in the longitudinal direction.

During the implementation, the resistance heating track 3120a has no portion directly located between the portion 3121a with an increased width and the portion 3122a with an increased width in the circumferential direction.

Alternatively, in more varied embodiments, for example, as shown in FIG. 7, a resistance heating track 3120c has more track segments, and then a plurality of repeatedly presented units, such as a unit 3124c, a unit 3125c, and a unit 3126c, which include a plurality of circuitous and crooked track segments, are formed between the track segment 3123c and the track segment 3129c. The plurality of repeatedly presented units 3124c, 3125c and 3126c may be generally U-shaped.

In the embodiment, the resistance heating track 3120a/3120c has a resistance value of approximately 1-1.2Ω.

In the embodiment, each track segment of the resistance heating track 3120a basically straightly extends. The resistance heating track 3120a has no arc-shaped curved portion. The resistance heating track 3120a has no arc-shaped curved portion and has only track segments extending in a longitudinal direction and perpendicular to the longitudinal direction. Alternatively, the resistance heating track 3120a has no track segment extending obliquely.

The track segments of the resistance heating track 3120a are sequentially connected in series between the portion 3121a with an increased width and/or the portion 3122a with an track segment.

The sheet 31a has only one resistance heating track 3120a that crookedly or circuitously extends between the portion 3121a with an increased width and the portion 3122a with an increased width. Alternatively, the sheet 31a does not include a plurality of resistance heating tracks 3120a connected in parallel between the portion 3121a with an increased width and the portion 3122a with an increased width.

Further, FIG. 6 is a schematic cross-sectional view of a heater 30 from a perspective. According to the embodiments shown in FIG. 2 and FIG. 6, the flange 33 has a non-centrosymmetric cross-sectional shape. In the embodiments, the flange 33 has an approximately D-shaped cross-sectional shape.

Further, as shown in FIG. 2 and FIG. 6, the outer side surface 3330 surrounding the flange 33 in the circumferential direction includes: a surface 331, a surface 332, a surface 333, and a surface 334 that are sequentially provided in the circumferential direction. The surface 331, the surface 332, and the surface 334 are flat surfaces, and the surface 333 is an arc-shaped curved surface. A radian of the surface 333 in the circumferential direction is π, that is, the surface 333 is in the shape of a semicircular arc. It should be noted that, in some other embodiments, a quantity of flat surfaces and a quantity of cambered surfaces are not limited, and only at least one flat surface and at least one cambered surface are needed. The radian of the cambered surface is not limited. That is, the outer side surface 3330 includes at least one flat plane and at least one curved circular arc surface.

Further, as shown in FIG. 2 and FIG. 6, the surface 332 and the surface 334 face away from each other in a length direction of the flange 33; and the surface 331 and the surface 333 face away from each other in a width direction of the flange 33. The surface 332 and the surface 334 are parallel.

The surface 332 and the surface 331 are perpendicular to each other, and then an angle 335 is defined at a joint between the surface 332 and the surface 331; and the surface 334 and the surface 331 are perpendicular to each other, and then an angle 336 is defined at a joint between the surface 334 and the surface 331. The angle 335 and the angle 336 are right angles.

Further, as shown in FIG. 6, a dimension d21 by which the surface 331 straightly extends in the circumferential direction is 4-6 mm; and a length dimension of the flange 33 is 4-6 mm. For example, in a specific embodiment, the dimension d21 by which the surface 331 extends in the circumferential direction is 4.9 mm.

A distance between two ends of the semicircular arc surface 333 or a diameter of a virtual cylinder R2 defined by the semicircular arc surface 333 is equal to the length dimension d1 of the flange 33, that is, 4-6 mm. The length by which the semicircular arc surface 333 extends=d1×π/2.

A width dimension d22 of the flange 33 is 3.5-5.5 mm; and for example, in a specific embodiment, the width dimension d22 of the flange 33 is 4.5 mm.

A dimension d23 by which each of the surface 332 and the surface 334 extends in the circumferential direction of the flange 33 is 2.05 mm. The dimension d23 is less than ½ of the width dimension d22 of the flange 33.

The virtual cylinder R2 defined by the semicircular arc surface 333 has the same central axis O as the tubular heating member 31. Therefore, a distance d24 between the central axis O and any position on the semicircular arc surface 333 is the same, that is, a radius of the virtual cylinder R2. Specifically, the distance d24 is ½ of d21. An outer diameter of the tubular heating member 31 is d26, and a distance d25 between the outer surface of the tubular heating member 31 and any position on the virtual cylinder R2 defined by the semicircular arc surface 333 is the same, that is, the distance d25=(d21−d26)/2.

A minimum distance between the central axis O of the tubular heating member 31 or the central axis O of the virtual cylinder R2 defined by the semicircular arc surface 333 and the surface 331 is d23, which is less than the distance d24 between the central axis O and any position on the surface 333. A maximum distance between the central axis O of the tubular heating member 31 and the surface 331 is a distance between the central axis O and a connection line of the angle 335, and is greater than the distance d24 between the central axis O and any position on the surface 333. It can be understood that the surface 331 and the surface 333 are a first side surface and a second side surface of the flange 33.

Further referring to FIG. 6, the heating member 31 has 3.5 winding layers formed by winding a sheet 31a, or in more varied embodiments, the heating member 31 may have 1.5, 2.5 or 4.5 or a different number of winding layers formed by winding the sheet 31a. A virtual line L1 that connects an innermost end 311 to an outermost end 312 of the heating member 31 with 3.5 winding layers passes through the central axis O.

Further, as shown in FIG. 6, the virtual line L1 that connects the innermost end 311 to the outermost end 312 of the heating member 31 formed by winding the sheet 31a clockwise R1 basically passes through a vertex of the angle 335, or the virtual line L1 that connects the innermost end 311 to the outermost end 312 passes through a vertex of the angle 336. This is beneficial to accurately positioning the heating member 31 with 1.5, 2.5, 3.5 or 4.5 winding layers to the flange 33.

In the embodiment, the heating member 31 formed by winding the sheet 31a includes a non-integer number of winding layers.

Further, as shown in FIG. 2 and FIG. 6, the outer side surface 3330 surrounding the flange 33 in the circumferential direction has non-centrosymmetry. The outer side surface 3330 is configured to have an asymmetry of rotating by 180° around a central axis and/or the central axis O of the heating member 31. Alternatively, the surface 3310 of the flange 33 also has an asymmetric shape. The surface 3310 of the flange 33 is asymmetrical in at least one of the length direction or the width direction.

Further, as shown in FIG. 6, a wire groove is provided in an inner side surface of the flange 33 around the heating member 31, and includes, for example, a wire groove 3511 and a wire groove 3521. After assembly, the conductive pin 351 at least partially passes through the wire groove 3511 to the outside of the tail end 320; and the conductive pin 352 at least partially passes through the wire groove 3521 to the outside of the tail end 320.

In some embodiments, the wire groove 3511 and the wire groove 3521 are invisible from the surface 3310 and/or an upper end side of the flange 33. The wire groove 3511 and the wire groove 3521 are visible from the surface 3320 and/or a lower end side of the flange.

The wire groove 3511 and the wire groove 3521 face away from in a radial direction of the heating member 31, that is, they are located on two sides of the heating member 31 in the radial direction, respectively. Correspondingly, the portion 3121a with an increased width and the portion 3122a with an increased width, which are used for electrical connection of the resistance heating track 3120a, also face away from each other in the radial direction of the heating member 31 after winding, and are also located on two the sides of the heating member 31 in the radial direction, respectively.

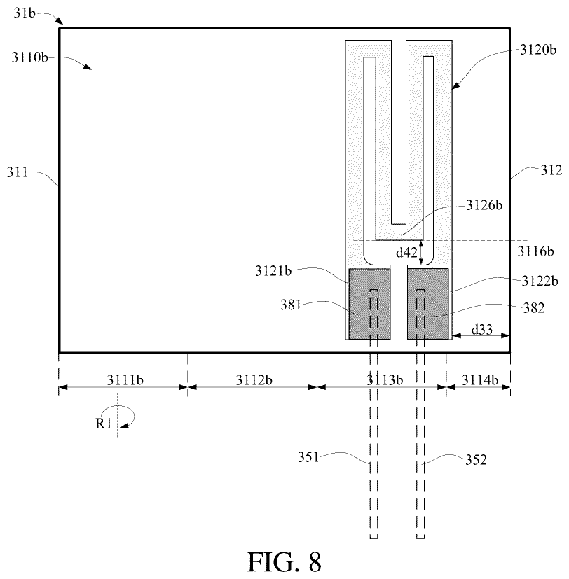

Alternatively, FIG. 8 is a schematic diagram of a sheet 31b according to another embodiment before winding, which includes:
a windable sheet-like substrate 3110b, which is, for example, a thin film formed by casting a ceramic slurry, and is roughly configured in a square or rectangular shape, where the sheet-like substrate 3110b has a dimension capable of winding 3.5 winding layers; and
a resistance heating track 3120b formed on a surface of the windable substrate 3110b by printing, spraying, or other means.

In this embodiment, the resistance heating track 3120b has a relatively larger extension length in the longitudinal direction of the sheet 31b.

The resistance heating track 3120b has a portion 3121b with an increased width and a portion 3122b with an increased width at a position close to the lower end/tail end 320, to define an electrical connection region for supplying power to the resistance heating track 3120b.

After winding, the conductive pin 351 is connected to the portion 3121b with an increased width; and the conductive pin 352 is connected to the portion 3122b with an increased width. In the embodiment, the heater 30 further includes:
a covering layer 381, which is formed by cooling and solidifying a molten precursor outside the portion 3121b with an increased width, and covers and coats the conductive pin 351 and the portion 3121b with an increased width, to securely connect the conductive pin 351 to the portion 3121b with an increased width;
and a covering layer 382, which is formed by cooling and solidifying a molten precursor outside the portion 3122b with an increased width, and covers and coats the conductive pin 352 and the portion 3122b with an increased width, to securely connect the conductive pin 352 to the portion 3122b with an increased width.

The covering layer 381 and/or the covering layer 382 includes glass, glaze, or a metal such as tin, or the like.

The covering layer 381 and/or the covering layer 382 is exposed on the surface of the heating member 31.

In some embodiments, after being combined with the heating member 31, the flange 33 avoids the covering layer 381 and/or the covering layer 382, or the flange 33 is closer to the tail end 30 than the covering layer 381 and/or the covering layer 382.

Alternatively, in some implementations, after the flange 33 is combined with the heating member 31, the covering layer 381 and/or the covering layer 382 is partially surrounded by the flange 33 and partially exposed outside the flange 33.

Alternatively, in some other varied embodiments, for example, as shown in FIG. 8, among circuitously and crookedly extending track segments of the resistance heating track 3120b, there is a track segment 3126b that is closest to the portion 3121b with an increased width and the portion 3122b with an increased width in a longitudinal direction. Certainly, there is a distance d42 between the track segment 3126b and the portion 3121b with an increased width and/or the portion 3122b with an increased width in the longitudinal direction. In this varied embodiment, the flange 33 surrounds and is combined in a region 3116b defined by the distance d42.

In the embodiment shown in FIG. 8, the resistance heating track 3120b has a relatively small width. For example, in FIG. 8, the width of the resistance heating track 3120b is approximately close to the width of one winding of the sheet 31b. A distance d33 between the resistance heating track 3120b and the second side 312 is less than the width of 0.5 winding, so that the resistance heating track 3120b after winding is at least partially exposed on the outer surface of the wound heating member 31. Alternatively, the resistance heating track 3120b is closer to the outer surface of the tubular heating member 31 than to an inner surface of the tubular heating member 31.

It should be noted that, the specification and the accompanying drawings of this application illustrate preferred embodiments of this application, but this application is not limited to the embodiments described in this specification. Further, a person of ordinary skill in the art may make improvements or modifications according to the foregoing description, and all the improvements and modifications shall fall within the protection scope of the appended claims of this application.

1. An aerosol generating apparatus configured to heat an aerosol generating product to generate an aerosol, comprising:
a heater for being inserted into the aerosol generating product for heating, wherein the heater comprises a free front end and a tail end facing away from each other in a length direction, and
a heating member at least partially extending between the free front end and the tail end, wherein the heating member comprises a first section close to the free front end and a second section close to the tail end; a color of an outer surface of the first section is different from that of an outer surface of the second section; and
a flange at least partially surrounding or combined with the second section, wherein the aerosol generating apparatus holds the heater by means of the flange.

2. The aerosol generating apparatus according to claim 1, wherein a color difference between the color of the outer surface of the first section and the color of the outer surface of the second section are configured to be recognizable by a color sensor or human eyes.

3-4. (canceled)

5. The aerosol generating apparatus according to claim 1, wherein the heater comprises:
a surface coating that coats or is formed on the first section and avoids the second section, and therefore the surface coating defines different colors of the outer surface of the first section and the outer surface of the second section.

6. The aerosol generating apparatus according to claim 5, wherein the surface coating comprises silicon dioxide and zirconia.

7-8. (canceled)

9. The aerosol generating apparatus according to claim 1, wherein the outer surface of the second section is rougher than the outer surface of the first section, such that the outer surface of the second section has greater friction to prevent the flange from moving relative to the second section.

10-15. (canceled)

16. The aerosol generating apparatus according to claim 1, wherein:
the flange comprises a first surface close to or facing the free front end; and the first surface is substantially flush with a joint between the first section and the second section; and
the first surface is asymmetrical in at least one of the length direction or a width direction.

17. The aerosol generating apparatus according to claim 1, wherein:
the flange comprises a first surface close to or facing the free front end; and the first surface is substantially flush with a joint between the first section and the second section; and
the first surface has an asymmetry of rotating by 180° around a central axis of the heating member.

18-20. (canceled)

21. The aerosol generating apparatus according to claim 1, wherein the flange comprises an outer side surface surrounding the flange in a circumferential direction, and
the outer side surface is asymmetrical with respect to a central axis of the heating member.

22. (canceled)

23. The aerosol generating apparatus according to claim 1, wherein:
the flange comprises a first surface close to or facing the free front end; and the first surface is substantially flush with a joint between the first section and the second section; and
the heater further comprises:
a coating material at least partially covering a joint gap between the flange and the heating member on the first surface, to prevent residues or an aerosol condensate from the aerosol generating product from entering the joint gap along an outer surface of the heating member.

24. The aerosol generating apparatus according to claim 1, wherein:
the flange comprises a first surface close to or facing the free front end; and the first surface is substantially flush with a joint between the first section and the second section; and
the heater further comprises:
a bonding material at least partially entering or penetrating into a joint gap between the flange and the heating member from the first surface, to securely bond the flange to the heating member.

25-37. (canceled)

38. The aerosol generating apparatus according to claim 1, wherein the heating member is formed by winding a sheet.

39-56. (canceled)

57. The aerosol generating apparatus according to claim 1, wherein the heating member comprises:
a substrate and a resistance heating track combined on the substrate.

58. The aerosol generating apparatus according to claim 57, wherein the resistance heating track comprises:
a plurality of track segments circuitously extending in a length direction and a circumferential direction of the heating member.

59-60. (canceled)

61. The aerosol generating apparatus according to claim 1, wherein:
the resistance heating track is defined with an electrical connection region close to the tail end, to conduct a current on the resistance heating track; and
a track width of the resistance heating track in the electrical connection region is greater than that in other parts.

62. The aerosol generating apparatus according to claim 1, wherein:
the resistance heating track is defined with an electrical connection region close to the tail end, to conduct a current on the resistance heating track;
the resistance heating track comprises at least one track segment extending in a circumferential direction of the heating member; and
a spacing region defined between the electrical connection region and a closest track segment in a longitudinal direction of the heating member, wherein the flange is at least partially combined in the spacing region.

63-66. (canceled)

67. The aerosol generating apparatus according to claim 1, wherein:
the heater further comprises a conductive pin electrically connected to the heating member, to conduct a current on the heating member; and
a position at which the conductive pin is electrically connected to the heating member is located in the first section.

68. The aerosol generating apparatus according to claim 1, wherein:
the heater further comprises a conductive pin electrically connected to the heating member, to conduct a current on the heating member;
the heating member is defined with an electrical connection region for electrical connection with the conductive pin; and
the electrical connection region is closer to the free front end than the flange.

69-70. (canceled)

71. The aerosol generating apparatus according to claim 1, wherein:
the heater further comprises a conductive pin electrically connected to the heating member, to conduct a current on the heating member; and
the heater further comprises:
a covering layer covering at least the conductive pin outside the heating member to fasten the conductive pin to the heating member.

72-74. (canceled)

75. The aerosol generating apparatus according to claim 1, wherein:
the heater further comprises a conductive pin electrically connected to the heating member, to conduct a current on the heating member;
the heating member is defined with an electrical connection region for electrical connection with the conductive pin; and
a covering layer is formed by cooling and solidifying a molten precursor in the electrical connection region, and at least partially covers the electrical connection region.

76-100. (canceled)
